(19) United States
(12) Patent Application Publication
(10) Pub. No.: US 2023/0162886 A1
(43) Pub. Date: May 25, 2023

(54) HEAT-RESISTANT INSULATED WIRE

(71) Applicant: TOTOKU ELECTRIC CO., LTD., Tokyo (JP)

(72) Inventors: Katsuo HANYU, Ueda-shi, Nagano (JP); Hiroshi KITAZAWA, Ueda-shi, Nagano (JP); Shohei KOMAMURA, Ueda-shi, Nagano (JP); Yuichi NAKAJYO, Ueda-shi, Nagano (JP); Yuki SHIMIZU, Ueda-shi, Nagano (JP); Makoto MIYASHITA, Ueda-shi, Nagano (JP)

(73) Assignee: TOTOKU ELECTRIC CO., LTD., Tokyo (JP)

(21) Appl. No.: 17/919,181

(22) PCT Filed: Apr. 16, 2021
(86) PCT No.: PCT/JP2021/015692

§ 371 Date: Oct. 14, 2022

(30) Foreign Application Priority Data
Apr. 16, 2020 (JP) 2020-073286

(51) Int. Cl. H01B 7/29; H01B 3/44

(52) U.S. Cl. CPC H01B 7/292; H01B 3/445

(57) ABSTRACT

A heat-resistant insulated wire that is used for a wiring or a winding in a device, has a high partial discharge starting voltage, and can achieve heat resistance and oxidation suppression of a conductor surface. The heat-resistant insulated wire (10) comprising a conductor (1), a baked film layer (2) provided on an outer periphery of the conductor (1), and an insulating film (3) provided on the baked film layer (2). The baked film layer (2) is a thermosetting resin layer, and the insulating film (3) is an extrusion-coated fluororesin layer. Preferably the baked film layer (2) is a urethane resin layer and has a thickness within a range of 5 to 30 μm, and preferably a diameter of the conductor (1) is within a range of 0.08 to 0.30 mm and a thickness of the insulating film (3) is within a range of 0.05 to 0.10 mm.

### FIELD OF THE INVENTION

The present invention relates to a heat-resistant insulated wire used for a wiring or a winding in a device.

### BACKGROUND ART

Insulated wires are used in various products. In a case in which an insulated wire is used as a winding for a coil or the like of a rotating electrical device such as a motor, the insulated wire is used with high voltages applied. At this time, a severe partial discharge (corona discharge) may occur on an insulation-coated surface. Such partial discharge is a phenomenon caused by accelerated deterioration of the insulating coating due to local temperature rise and generation of ozone and ions. The occurrence of partial discharges causes the problem of shortening the life of the device in which the component is used.

In recent years, with the increasing demand for compact and high-power motors, coils that can increase the applied voltage are in need. However, when the applied voltage is increased, an electrical field strength increases and partial discharge is more likely to occur. In response to such problems, it is desirable to increase the voltage at which partial discharge occurs (referred to as partial discharge starting voltage), and thus, to increase the partial discharge starting voltage, various measures have been taken, such as thickening the insulating coating of an enameled wire, thickening the insulating coating by resin extrusion, and lowering the dielectric constant of the insulating coating by foaming.

For example, Patent Document 1 proposes an insulated wire including an insulating film having a low dielectric constant and a high partial discharge starting voltage. This insulated wire is composed of a conductor and an insulating film covering the conductor, and the insulating film is formed by applying and baking a mixed resin of (A) one or more types of resins selected from polyamideimide resin, polyimide resin, polyesterimide resin, and H-class polyester resin, and (B) one or more types of resin selected from fluororesin and polysulfone resin.

### PRIOR ART DOCUMENTS

### Patent Documents

Patent Document 1: Japanese Laid-Open Patent Application Publication No. 2010-67521

### SUMMARY OF THE INVENTION

### Problems to be Solved by the Invention

An insulated wire used for a wiring or a winding in a device is required to have heat resistance and, in a case in which a fluororesin layer is provided as an insulating film layer constituting such a heat-resistant insulated wire, the fluororesin has a high melting point and a temperature thereof during extrusion molding must be increased to nearly 400° C., which makes a surface of the conductor susceptible to oxidation. Further, the fluororesin may generate hydrofluoric acid (hydrogen fluoride) when combusted, and the hydrofluoric acid may accelerate oxidation of the conductor surface. Furthermore, there is also the problem that an oxidized layer formed on the conductor surface is difficult to remove. To address such problems, it is common to apply a metal plating such as tin or nickel to the conductor surface to prevent oxidation, but this increases costs.

The present invention has been made to solve the above-described problems, and an object thereof is to provide a heat-resistant insulated wire that is used for a wiring or a winding in a device, has a high partial discharge starting voltage, and can achieve heat resistance and oxidation suppression of a conductor surface.

### Means for Solving the Problems

A heat-resistant insulated wire according to the present invention comprises a conductor, a baked film layer provided on an outer periphery of the conductor, and an insulating film provided on the baked film layer. The baked film layer is a thermosetting resin layer, and the insulating film is an extrusion-coated fluororesin layer.

According to this invention, the insulating film composed of a fluororesin layer is provided on the baked film layer, making it possible to prevent a conductor surface from being oxidized by heat or by generated hydrofluoric acid or the like during extrusion molding of the fluororesin. As a result, a heat-resistant insulated wire in which oxidation of the conductor surface is suppressed is achieved. Further, the fluororesin layer has heat resistance, and thus the insulated wire itself also has heat resistance. Furthermore, it is possible to use a magnet wire with the baked film layer formed on the conductor, and thus reduce a manufacturing cost compared to a case in which oxidation is prevented by metal plating and increase adhesion between the conductor and the baked film layer.

In the heat-resistant insulated wire according to the present invention, the baked film layer is a urethane resin layer and has a thickness within a range of 5 to 30 μm. This way, it is possible to utilize an enameled urethane wire and reduce the manufacturing cost.

In the heat-resistant insulated wire according to the present invention, a diameter of the conductor is within a range of 0.08 to 0.30 mm, and a thickness of the insulating film is within a range of 0.05 to 0.10 mm.

In the heat-resistant insulated wire according to the present invention, a withstand voltage is 4.0 kV or higher.

In the heat-resistant insulated wire according to the present invention, preferably the fluororesin layer is an ethylene tetrafluoro ethylene (ETFE) resin layer in a case in which the baked film layer is composed of general-purpose polyurethane, is a fluorinated ethylene propylene (FEP) resin layer in a case in which the baked film layer is composed of modified polyurethane, or is a perfluoroalkoxy alkane (PFA) resin layer in a case in which the baked film layer is composed of polyesterimide.

### Effect of the Invention

According to the present invention, it is possible to provide a heat-resistant insulated wire that is used for a wiring or a winding in a device, has a high partial discharge starting voltage, and can achieve heat resistance and oxidation suppression of a conductor surface.

### BRIEF DESCRIPTION OF THE DRAWINGS

FIG. 1 is an explanatory view illustrating an example of a heat-resistant insulated wire according to the present invention.

FIG. 2 is a cross-sectional view of the heat-resistant insulated wire illustrated in FIG. 1.

### EMBODIMENTS OF THE INVENTION

A heat-resistant insulated wire according to the present invention will now be described with reference to the drawings. It should be noted that the present invention can be modified in various ways as long as the technical features set forth herein are present, and is not limited to forms of the descriptions and drawings below.

### Heat-Resistant Insulated Wire

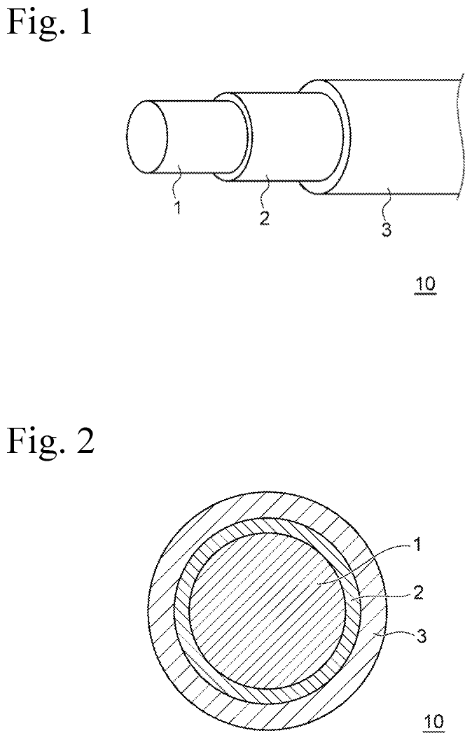

A heat-resistant insulated wire 10 according to the present invention, as illustrated in FIG. 1 and FIG. 2, includes a conductor 1, a baked film layer 2 provided on an outer periphery of the conductor 1, and an insulating film 3 provided on the baked film layer 2. As characteristics thereof, the heat-resistant insulated wire 10 is configured so that the baked film layer 2 is a thermosetting resin layer, and the insulating film 3 is an extrusion-coated fluororesin layer.

This heat-resistant insulated wire 10 is provided with the insulating film 3 composed of a fluororesin layer on the baked film layer 2, making it possible to prevent a conductor surface from being oxidized by heat or by generated hydrofluoric acid or the like during extrusion molding of the fluororesin. As a result, the heat-resistant insulated wire 10 in which oxidation of the conductor surface is suppressed is achieved. Further, the fluororesin layer has heat resistance, and thus the insulated wire itself also has heat resistance. Furthermore, it is possible to use a magnet wire with the baked film layer 2 formed on the conductor 1, and thus reduce a manufacturing cost compared to a case in which oxidation is prevented by metal plating and increase adhesion between the conductor 1 and the baked film layer 2.

In the following, each component will be described.

### (Conductor)

The conductor 1 is not particularly limited as long as applied as a center conductor of the heat-resistant insulated wire 10, in particular, the heat-resistant insulated wire 10 used for a wiring or a winding in a device, and may be any type of conductor, regardless of material and twist configuration. For example, the conductor 1 may be constituted by a single strand extending in a longitudinal direction, may be constituted by several strands twisted together, or may be configured as a litz wire. The type of strand is not particularly limited as long as composed of a metal having favorable conductivity, but preferable examples include a metal conductor having favorable conductivity, such as copper wire, copper alloy wire, aluminum wire, aluminum alloy wire, or copper-aluminum composite wire. Copper wire and copper alloy wire are particularly preferred from the standpoint of coil use.

It should be noted that, in the present invention, an enameled wire with the baked film layer 2 provided on the conductor 1 is used, and thus it has characteristics that do not require a plating layer to be provided on the conductor surface, making it possible to reduce the manufacturing cost compared to a case in which plating is provided. A cross-sectional shape of the strand is not particularly limited and, in the wire material thereof, may be circular or substantially circular, or may be rectangular.

A cross-sectional shape of the conductor 1 is also not particularly limited, and may be circular (including oval) or may be rectangular or the like. An outer diameter of the conductor 1 is also not particularly limited, but is preferably about 0.08 to 0.30 mm for a strand having a circular shape, for example.

### (Baked Film Layer)

The baked film layer 2, as illustrated in FIG. 1 and FIG. 2, is a thermosetting resin layer provided on the outer periphery of the conductor 1. In the present invention, it is possible to use a magnet wire with the baked film layer 2 formed on the conductor 1, and thus reduce the manufacturing cost compared to a case in which oxidation is prevented by metal plating and increase adhesion between the conductor 1 and the baked film layer 2.

The baked film layer 2 is not particularly limited to as long as the layer is a thermosetting resin layer, but examples include various enamel coating layers. Preferable examples include the baked film layer 2 obtained by applying and baking a solderable enamel coating, such as general-purpose polyurethane, modified polyurethane, and polyesterimide, and a urethane resin layer composed of general-purpose polyurethane or modified polyurethane is particularly preferred. A thickness of the baked film layer 2 is within a range of 5 to 30 μm. This way, it is possible to utilize an enameled urethane wire and reduce the manufacturing cost.

### (Insulating Film)

The insulating film 3, as illustrated in FIG. 1 and FIG. 2, is an extrusion-coated fluororesin layer provided on the baked film layer 2. The fluororesin constituting the fluororesin layer is not particularly limited, but examples include PFA, ETFE, FEP, and the like. These fluororesins have excellent heat resistance, making it possible to impart high heat resistance to the heat-resistant insulated wire 10. Further, fluororesins have a low dielectric constant, which is advantageous in terms of increasing the partial discharge starting voltage as well. Thus, in the present invention, the insulating film 3 composed of a fluororesin layer is provided on the baked film layer 2, making it possible to prevent the conductor surface from being oxidized by heat or by generated hydrofluoric acid or the like during extrusion molding of the fluororesin. As a result, a heat-resistant insulated wire in which oxidation of the conductor surface is suppressed is achieved.

A thickness of the insulating film 3 is preferably within a range of 0.05 to 0.10 mm, making it possible to set a withstand voltage (dielectric breakdown voltage) of the heat-resistant insulated wire 10 to 4.0 kV or higher, preferably 10.0 kV or higher. The withstand voltage is obtained by twisting two insulated wires and measuring the value with a withstand voltage tester.

The baked film layer 2 is provided under the insulating film 3, and thus oxidation of the conductor surface is unlikely to occur due to heat during extrusion, even for fluororesin having a relatively high extrusion temperature. It should be noted that an outermost periphery of the heat-resistant insulated wire 10 may be further provided with an insulating outer coating (not illustrated), as necessary.

### (Baked Film Layer and Insulating Film Combinations)

The insulating film 3 composed of a fluororesin layer of thermoplastic resin is not provided on the conductor 1, but is extrusion-molded directly onto the baked film layer 2 composed of thermosetting resin and provided on the conductor 1. In the baked film layer 2 described above, the difference between general-purpose polyurethane and modified polyurethane depends on the type of diisocyanate, which is the raw material of polyurethane and, as a result, the polymer structure skeleton of general-purpose polyurethane is a flexible structure skeleton, while the polymer structure skeleton of modified polyurethane is a rigid structure skeleton. Such a difference is manifested as differences in a thermal decomposition temperature and a soldering temperature. Polyesterimide has a higher thermal decomposition temperature (TGI: 140° C. to 150° C.) and a higher soldering temperature (420° C. to 460° C.) than general-purpose polyurethane and modified polyurethane. In the present invention, the baked film layer 2 composed of thermosetting resin functions to prevent the conductor surface from being oxidized at the extrusion temperature of the fluororesin layer described below, and therefore desirably has “thermal stability,” that is, is stable without decomposing at the extrusion temperature of the fluororesin layer as well, and desirably readily decomposes and has favorable “solderability” at the soldering temperature corresponding to the type of the baked film layer 2. For determining the coating that is most suitable among the general-purpose polyurethane (TGI: 120° C. to 130° C., soldering temperature: 320° C. to 360° C.), the modified polyurethane (TGI: 130° C. to 140° C., soldering temperature: 360° C. to 420° C.), and the polyesterimide (TGI: 140° C. to 150° C., soldering temperature: 420° C. to 460° C.) given as examples of the baked film layer 2, the relationship with the extrusion temperature of the fluororesin layer is important.

The baked film layer 2 is provided on the conductor 1 and coated and baked directly under the fluororesin layer, making it possible to prevent the conductor surface from being oxidized by the heat during extrusion molding of the fluororesin layer, which has a relatively high extrusion temperature. The extrusion temperature of the fluororesin layer differs depending on the type of fluororesin, and is, for example, about 330° C. to 420° C. for PFA, about 260° C. to 350° C. for ETFE, and about 280° C. to 380° C. for FEP. The descending order of extrusion temperature is PFA, FEP, and ETFE, with ETFE having the lowest extrusion temperature. Further, the degree of likelihood of hydrofluoric acid generation during extrusion molding is related to the extrusion temperature as well, and increases with a higher extrusion temperature. With the extrusion temperatures described above, PFA has the highest likelihood of generation, FEP has the next highest likelihood of generation, and ETFE has the least likelihood of generation.

In terms of the specific combination of the baked film layer 2 and the insulating film 3, when the insulating film 3 is extrusion-molded, the “thermal stability of the baked film layer 2,” that is, the unlikelihood of decomposition of the baked film layer 2 even when heat is applied during the extrusion molding is important and, as a result, it is possible to prevent oxidation of the conductor surface by heat or by hydrofluoric acid or the like during extrusion molding of the insulating film 3 by providing the baked film layer 2 having thermal stability. Furthermore, after extrusion molding of the insulating film 3, it is important to have favorable solderability at the soldering temperature. As described in Experiment 1 mentioned below, as a specific combination of the baked film layer 2 and the insulating film 3, a combination in which the insulating film 3 is an ETFE resin layer is preferred in a case in which the baked film layer 2 is general-purpose polyurethane, a combination in which the insulating film 3 is an FEP resin layer is preferred in a case in which the baked film layer 2 is modified polyurethane, and a combination in which the insulating film 3 is a PFA resin layer is preferred in a case in which the baked film layer 2 is polyesterimide.

That is, the general-purpose polyurethane may decompose with heat of 260° C. or higher and thus, in a case in which the fluororesin layer is extrusion-molded thereon, extrusion-molding ETFE, which has the lowest extrusion temperature, as the insulating film 3 is preferable from the standpoint of both thermal stability and solderability. The modified polyurethane may decompose with heat of 280° C. or higher and thus, in a case in which the fluororesin layer is extrusion-molded thereon, extrusion-molding FEP, which has a high extrusion temperature, as the insulating film 3 is preferable from the standpoint of both thermal stability and solderability. The polyesterimide may decompose with heat of 310° C. or higher and thus, in a case in which the fluororesin layer is extrusion-molded thereon, extrusion-molding PFA, which has the highest extrusion temperature, as the insulating film 3 is preferable from the standpoint of both thermal stability and solderability. With the heat-resistant insulated wire being constituted by such combinations, it is possible to preferably prevent the conductor surface from being oxidized by heat or by generated hydrofluoric acid or the like during extrusion molding of the fluororesin.

### EXAMPLES

The present invention will now be described in further detail through examples. The present invention is not limited to the following examples, and those skilled in the art may make various changes, modifications, and alterations within the scope of the present invention.

### Example 1

The heat-resistant insulated wire 10 having a total outer diameter of 0.374 mm was fabricated by using a magnet wire having a diameter of 0.270 mm obtained by providing the baked film layer 2 composed of urethane resin and having a thickness of 10 μm on a non-plated copper wire having a diameter of 0.250 mm, and providing the insulating film 3 composed of ETFE and having a thickness of 52 μm on an outer periphery of the magnet wire. The conductor resistance of the obtained heat-resistant insulated wire 10 was measured with a resistance meter and was 0.358 Ω/m. Further, the dielectric breakdown voltage was measured with a withstand voltage tester upon twisting two wires, and was 22.28 kV.

### Example 2

The heat-resistant insulated wire 10 having a total outer diameter of 0.238 mm was fabricated by using a magnet wire having a diameter of 0.134 mm obtained by providing the baked film layer 2 composed of urethane resin and having a thickness of 7 μm on a non-plated copper wire having a diameter of 0.120 mm, and providing the insulating film 3 composed of PFA and having a thickness of 52 μm on an outer periphery of the magnet wire. The conductor resistance and the dielectric breakdown voltage of the obtained heat-resistant insulated wire 10 were 1.556 Ω/m and 21.50 kV, respectively.

### Example 3

The heat-resistant insulated wire 10 having a total outer diameter of 0.302 mm was fabricated by using a magnet wire having a diameter of 0.200 mm obtained by providing the baked film layer 2 composed of urethane resin and having a thickness of 10 μm on a non-plated copper wire having a diameter of 0.180 mm, and providing the insulating film 3 composed of FEP and having a thickness of 51 μm on an outer periphery of the magnet wire. The conductor resistance and the dielectric breakdown voltage of the obtained heat-resistant insulated wire 10 were 0.691 Ω/m and 20.12 kV, respectively.

### Comparative Example 1

A heat-resistant insulated wire having a total outer diameter of 0.370 mm was fabricated by providing an insulating film composed of ETFE and having a thickness of 60 μm on a non-plated copper wire having a diameter of 0.250 mm, without providing a baked film layer. The conductor resistance and the dielectric breakdown voltage of the obtained heat-resistant insulated wire were 0.383 Ω/m and 17.08 kV, respectively.

### Experiment 1

Next, an experiment was conducted with the preferable combinations of the baked film layer 2 and the insulating film 3. The basic configuration was the same as that in Example 1. That is, the heat-resistant insulated wire 10 having a total outer diameter of 0.374 mm was fabricated by using a magnet wire having a diameter of 0.270 mm obtained by providing the baked film layer 2 composed of a single resin material (not a composite resin material; the same in this application) in a single layer (not a lamination; the same in this application) having a thickness of 10 μm on a non-plated copper wire having a diameter of 0.250 mm, and providing the insulating film 3 composed of a single resin material in a single layer having a thickness of 52 μm on an outer periphery of the magnet wire. It should be noted that the general-purpose polyurethane used in this example section, including the above-described Examples 1 to 3, was a general-purpose polyurethane (TGI: 125° C., soldering temperature: 360° C.) baked with an enamel coating of the trade name TPU-5100 manufactured by Totoku Toryo Co., Ltd. Further, the modified polyurethane below was a modified polyurethane (TGI: 130° C., soldering temperature: 380° C.) baked with an enamel coating of the trade name TSF-400N manufactured by Totoku Toryo Co., Ltd. Furthermore, the polyesterimide below was a polyesterimide (TGI: 140° C., soldering temperature: 460° C.) baked with an enamel coating of the trade name TSF-500 manufactured by Totoku Toryo Co., Ltd.

The combinations of the baked film layer 2 and the insulating film 3 used in the experiment were as follows.

(Sample 1) General-purpose polyurethane and PFA (extrusion temperature: 330° C. to 420° C.)
(Sample 2) General-purpose polyurethane and ETFE (extrusion temperature: 260° C. to 350° C.)
(Sample 3) General-purpose polyurethane and FEP (extrusion temperature: 280° C. to 380° C.)
(Sample 4) Modified polyurethane and PFA (extrusion temperature: 330° C. to 420° C.)
(Sample 5) Modified polyurethane and ETFE (extrusion temperature: 260° C. to 350° C.)
(Sample 6) Modified polyurethane and FEP (extrusion temperature: 280° C. to 380° C.)
(Sample 7) Polyesterimide and ETFE (extrusion temperature: 260° C. to 350° C.)
(Sample 8) Polyesterimide and PFA (extrusion temperature: 330° C. to 420° C.)
(Sample 9) Polyesterimide and ETFE (extrusion temperature: 260° C. to 350° C.)

### (Evaluation)

For Samples 1 to 9, thermal stability, solderability, and the oxidation state of the conductor surface were evaluated. For thermal stability, the dielectric breakdown voltage of the obtained heat-resistant insulated wire was evaluated in the same manner as in the above-described Examples 1 to 3, and evaluated as “◯” in a case in which the dielectric breakdown voltage was 10 kV or higher and “Δ” in a case in which the dielectric breakdown voltage was less than 10 kV. For solderability, the obtained heat-resistant insulated wires immersed and soldered in 96.5% tin solder at 360° C., 380° C., and 460° C. were visually confirmed, and evaluated as “◯” in a case in which favorable solderability was confirmed and “Δ” in a case in which unfavorable solderability was confirmed. The oxidation state of the conductor surface was evaluated by peeling off the insulating film 3 and baked film layer 2 of the obtained heat-resistant insulated wire and visually observing the conductor surface with a microscope to determine whether the surface was oxidized. The state was evaluated as “◯” in a case in which no oxidation was confirmed on the conductor surface and “Δ” in a case in which oxidation was confirmed.

TABLE 1

| | | | Oxidation State of |
|---|---|---|---|
| | Thermal Stability | Solderability | Conductor Surface |
| Sample 1 | ◯ | ◯ | ◯ |
| Sample 2 | ◯ | ◯ | ◯ |
| Sample 3 | ◯ | ◯ | ◯ |
| Sample 4 | ◯ | Δ | ◯ |
| Sample 5 | ◯ | Δ | ◯ |
| Sample 6 | ◯ | Δ | ◯ |
| Sample 7 | ◯ | Δ | ◯ |
| Sample 8 | ◯ | Δ | ◯ |
| Sample 9 | ◯ | Δ | ◯ |

### DESCRIPTIONS OF REFERENCE NUMERALS

1 Conductor
2 Baked film layer
3 Extruded coating layer (Insulating coating)
10 Heat-resistant insulated wire

1. A heat-resistant insulated wire comprising:
a conductor;
a baked film layer provided on an outer periphery of the conductor; and
an insulating film provided on the baked film layer,
the baked film layer being a thermosetting resin layer, and
the insulating film being an extrusion-coated fluororesin layer.

2. The heat-resistant insulated wire according to claim 1, wherein the baked film layer is a urethane resin layer and has a thickness within a range of 5 to 30 μm.

3. The heat-resistant insulated wire according to claim 1, wherein
a diameter of the conductor is within a range of 0.08 to 0.30 mm, and a thickness of the insulating film is within a range of 0.05 to 0.10 mm.

4. The heat-resistant insulated wire according to claim 1, wherein
a withstand voltage is 4.0 kV or higher.

5. The heat-resistant insulated wire according to claim 1, wherein
the fluororesin layer is an ETFE resin layer in a case in which the baked film layer is composed of general-purpose polyurethane, is an FEP resin layer in a case in which the baked film layer is composed of modified polyurethane, or is a PFA resin layer in a case in which the baked film layer is composed of polyesterimide.
